(19) United States
(12) Patent Application Publication
(10) Pub. No.: US 2020/0332095 A1
(43) Pub. Date: Oct. 22, 2020

(54) COMPOSITE, ARTICLE, BATTERY CASE, AND BATTERY

(71) Applicant: SAMSUNG ELECTRONICS CO., LTD., Suwon-si (KR)

(72) Inventors: Eun Sung LEE, Hwaseong-si (KR); Joungeun YOO, Seongnam-si (KR); Sung Dug KIM, Suwon-si (KR); Victor ROEV, Hwaseong-si (KR)

(21) Appl. No.: 16/825,244

(22) Filed: Mar. 20, 2020

(30) Foreign Application Priority Data
Mar. 22, 2019 (KR) 10-2019-0032718
Mar. 20, 2020 (KR) 10-2020-0034686

(51) Int. Cl. C08L 23/06; C08K 3/04; C08K 3/20; H01M 2/02

(52) U.S. Cl. CPC C08L 23/06; C08K 3/04; H01M 2004/028; H01M 2/0257; C08K 3/20

(57) ABSTRACT

A composite including a polymer matrix, a carbonaceous support or a transparent support, and an inorganic moisture absorber on the carbonaceous support or the transparent support, an article including the composite, a battery case including the composite, and a battery including the battery case and an electrode assembly in the battery case.

### CROSS-REFERENCE TO RELATED APPLICATION

This application claims priority to and the benefit of Korean Patent Application Nos. 10-2019-0032718 and 10-2020-0034686, filed in the Korean Intellectual Property Office on Mar. 22, 2019 and Mar. 20, 2020, respectively, and the benefits therefrom under 35 U.S.C. § 119, the content of which in its entirety is herein incorporated by reference.

### BACKGROUND

### 1. Field

This disclosure relates to a composite, an article, a battery case, and a battery.

### 2. Description of the Related Art

As various types of mobile electronic device and various types of means of electric transportation such as commercial or passenger vehicles are developed, the need for protecting power sources is becoming more important. A case may protect a power source, for example, a battery for supplying electric power (or power) to various types of mobile electronic devices or means of electric transportation such as commercial or passenger vehicles, from external moisture or impact. A battery may be accommodated in a case and disposed individually or as a module in the devices or means of transportation. Technology capable of improving properties of the case is desirable.

### SUMMARY

An embodiment provides a composite having improved moisture transmission resistivity, mechanical properties, thermal conductivity, and flame retardancy.

An embodiment provides an article including the composite.

An embodiment provides a battery case including the composite.

An embodiment provides a battery including the battery case.

An embodiment provides a composite including a polymer matrix, carbonaceous support, and an inorganic moisture absorber on the carbonaceous support.

The polymer matrix may include a polycarbonate, a polyolefin, a polyvinyl, a polyamide, a polyester, a polyphenylene sulfide (PPS), a polyphenylene ether, a polyphenylene oxide, a polystyrene, a polyamide, a polycyclic olefin copolymer, an acrylonitrile-butadiene-styrene copolymer, a liquid crystal polymer (LCP), a copolymer thereof, or a combination thereof.

The polymer matrix may include a high density polyethylene (HDPE), a liquid crystal polymer (LCP), or a combination thereof.

The carbonaceous support may have a specific surface area of greater than or equal to about 100 square meters per gram (m²/g) and a D₅₀ particle diameter of an aggregate of the carbonaceous support may be greater than or equal to about 0.1 micrometers.

The carbonaceous support may include carbon black, ketjen black, graphite, expanded graphite, a carbon fiber, a carbon nanoplate, or a combination thereof.

The carbonaceous support may include carbon black.

The inorganic moisture absorber may include silica gel, zeolite, CaO, BaO, MgSO₄, Mg(ClO₄)₂, MgO, P₂O₅, Al₂O₃, CaH₂, NaH, LiAlH₄, CaSO₄, Na₂SO₄, Na₂CO₃, CaCO₃, K₂CO₃, CaCl₂), Ba(ClO₄)₂, Ca, or a combination thereof.

The inorganic moisture absorber may include MgO, CaO, or a combination thereof.

The inorganic moisture absorber may have a D₅₀ particle diameter of greater than or equal to about 5 nanometers (nm) and less than about 1 micrometer.

A total amount of the carbonaceous support and the supported inorganic moisture absorber may be greater than or equal to about 5%, based on a total weight, e.g., mass, of the composite.

An amount of the inorganic moisture absorber in the composite may be about 3% to about 50%, based on a total weight, e.g., mass, of the carbonaceous support.

The composite may further include an oligomer or a polymer dissolvable in a solvent having a solubility parameter of about 15 megaPascals^{1/2} (MPa^{1/2}) to about 30 MPa^{1/2}, and the oligomer or polymer may include an amino group, a hydrophobic functional group, an amphiphilic functional group, or a combination thereof.

The hydrophobic functional group of the oligomer or polymer may include an aliphatic hydrocarbon group, an alicyclic hydrocarbon group, an aromatic hydrocarbon group, a (meth)acryloyl group, a halogen-substituted aliphatic hydrocarbon group, a halogen-substituted alicyclic hydrocarbon group, a halogen-substituted aromatic hydrocarbon group, or a combination thereof.

The oligomer or polymer may include an amino group and an amine value of the amino group may be in a range of about 1 milligrams of potassium hydroxide per gram (mg KOH/g) to about 100 mg KOH/g.

The oligomer or polymer may be present in an amount of less than or equal to about 50 parts by weight per 100 parts by weight of the carbonaceous support.

An article according to an embodiment includes the composite according to an embodiment.

The article may have a water vapor transmission rate (WVTR) of less than about 0.4 grams per square meter per day (g/m²/day) when measured at a thickness of a thickness of 1 millimeters (mm) at 38° C. under relative humidity of 100% according to ISO 15106.

A battery case according to an embodiment includes the composite according to an embodiment.

A battery according to an embodiment includes the battery case according to an embodiment and an electrode assembly including a positive electrode and a negative electrode within the battery case.

A composite according to an embodiment includes a polymer matrix, a transparent support, and an inorganic moisture absorber on the transparent support.

The transparent support may include mesoporous silica, mesoporous amorphous silica, porous alumina, or a porous metal oxide configured to form a metal-organic framework (MOF), and a D₅₀ particle diameter of the inorganic moisture absorber may be less than or equal to about 40 nm.

The composite according to an embodiment includes the polymer matrix, the carbonaceous support, and an inorganic moisture absorber, e.g., a nano-sized inorganic moisture absorber, on the carbonaceous support dispersed in the polymer matrix, and the inorganic moisture absorber that is not well-dispersed in the polymer matrix and is aggregated may be included in a large amount in an efficiently dispersed form, and mechanical properties may not be deteriorated, and tensile strength may be increased while moisture transmission resistivity is increased. In addition, the carbonaceous support may improve thermal conductivity and may ensure flame retardancy. Further, even if a low-cost polymer material, such as a polyolefin, is included as the polymer matrix, the aforementioned properties may be realized and the composite may be easily formed into various sizes and shapes. The composite according to an embodiment and the article including the same may have a light weight and a freedom of shape, and may be used as exterior cases for a variety of products having desirable moisture transmission resistivity, mechanical properties, heat dissipation properties, and flame retardancy, for example, energy storage devices such as rechargeable lithium batteries, electronic devices, display devices, portable electronic devices, and the like.

### BRIEF DESCRIPTION OF THE DRAWINGS

FIG. 1 is an exploded perspective view showing a battery case according to an embodiment.

FIG. 2 is an exploded perspective view showing a battery case according to an embodiment.

FIG. 3 is a thermogravimetric analysis (TGA) graph of weight (percent (%)) versus temperature (° C.) for magnesium oxide (MgO)-supported carbon black.

FIG. 4 is a transmission electron microscopy (TEM) photograph of carbon-supported magnesium oxide (CSMO).

FIG. 5 is a graph of water vapor transmission rate (WVTR) (milligrams per square meter per day (mg/m²/day)) versus amount (contents) of the carbon-supported magnesium oxide (CSMO) filler (weight percent (wt. %)).

FIG. 6 is a graph of tensile modulus (strength) (kilograms per square centimeter (kg/cm²)) and internal impact strength (kilojoules per square meter (kJ/m²)) versus the amount (contents) of carbon-supported magnesium oxide filler (wt. %).

FIG. 7 is a graph of thermal conductivity (watts per meter-Kelvin (W/mK)) versus the amount (contents) of carbon-supported magnesium oxide filler (wt. %).

### DETAILED DESCRIPTION

Hereinafter, embodiments of the present invention are described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout. However, these embodiments are exemplary, the present invention is not limited thereto, and the present invention is defined by the scope of claims. If not defined otherwise, all terms (including technical and scientific terms) in the specification may be defined as commonly understood by one skilled in the art. The terms defined in a generally-used dictionary may not be interpreted ideally or exaggeratedly unless clearly defined. In addition, unless explicitly described to the contrary, the word “comprise” and variations such as “comprises” or “comprising” will be understood to imply the inclusion of stated elements but not the exclusion of any other elements. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

A “combination” is inclusive of mixtures, alloys, and the like of two or more components.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

In the drawings, the thickness of each element is exaggerated for better comprehension and ease of description. Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. It will be understood that when an element such as a layer, film, region, or plate is referred to as being “on” another element, it can be directly on the other element or intervening elements may also be present. In contrast, when an element is referred to as being “directly on” another element, there are no intervening elements present. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

As used herein, when a definition is not otherwise provided, “alicyclic hydrocarbon group” may refer to a C3 to C30 cycloalkyl group, a C3 to C30 cycloalkenyl group, or a C3 to C30 cycloalkynyl group.

As used herein, when a definition is not otherwise provided, “aliphatic” may refer to a C1 to C30 linear or branched alkyl group, a C2 to C30 linear or branched alkenyl group, or a C2 to C30 linear or branched alkynyl group.

As used herein, when a definition is not otherwise provided, “alkenyl” may refer to a straight or branched chain, monovalent hydrocarbon group having at least one carbon-carbon double bond (e.g., ethenyl (—HC═CH₂)).

As used herein, when a definition is not otherwise provided, “alkoxy” may refer to an alkyl group that is linked via an oxygen (i.e., alkyl-O—), for example methoxy, ethoxy, and sec-butyloxy groups.

As used herein, when a definition is not otherwise provided, “alkyl” may refer to a straight or branched chain, saturated, monovalent hydrocarbon group (e.g., methyl or hexyl).

As used herein, when a definition is not otherwise provided, “alkylene” may refer to a straight or branched chain, saturated, divalent aliphatic hydrocarbon group, (e.g., methylene (—CH₂—) or, propylene (—(CH₂)₃—)).

As used herein, when a definition is not otherwise provided, “alkynyl” may refer to a straight or branched chain, monovalent hydrocarbon group having at least one carbon-carbon triple bond (e.g., ethynyl).

As used herein, when a definition is not otherwise provided, “amino group” may refer to a group of the general formula —N(R)₂, wherein each R is independently hydrogen, a C1 to C6 alkyl, or a C6 to C12 aryl.

As used herein, when a definition is not otherwise provided, “arene” may refer to a hydrocarbon having an aromatic ring, and includes monocyclic and polycyclic hydrocarbons wherein the additional ring(s) of the polycyclic hydrocarbon may be aromatic or nonaromatic. Specific arenes include benzene, naphthalene, toluene, and xylene.

As used herein, when a definition is not otherwise provided, “aromatic” may refer to a C6 to C30 aryl group or a C2 to C30 heteroaryl group.

As used herein, when a definition is not otherwise provided, “aryl” may refer to a monovalent group formed by the removal of one hydrogen atom from one or more rings of an arene (e.g., phenyl or naphthyl).

As used herein, when a definition is not otherwise provided, “arylalkylene” group may refer to an aryl group linked via an alkylene moiety. The specified number of carbon atoms (e.g., C7 to C30) means the total number of carbon atoms present in both the aryl and the alkylene moieties. Representative arylalkylene groups include, for example, benzyl, which is a C7 arylalkylene group.

As used herein, when a definition is not otherwise provided, “carbocyclic” may refer to a cyclic group having at least one ring with only carbon atoms in the ring. One or more rings may be present, and each ring may be saturate, unsaturated, or aromatic.

As used herein, when a definition is not otherwise provided, “cycloalkenyl” may refer to a monovalent hydrocarbon group having one or more rings and one or more carbon-carbon double bond in the ring, wherein all ring members are carbon (e.g., cyclopentyl and cyclohexyl).

As used herein, when a definition is not otherwise provided, “cycloalkyl” may refer to a monovalent hydrocarbon group having one or more saturated rings in which all ring members are carbon (e.g., cyclopentyl and cyclohexyl).

As used herein, when a definition is not otherwise provided, “cycloalkynyl” may refer to a stable aliphatic monocyclic or polycyclic group having at least one carbon-carbon triple bond, wherein all ring members are carbon (e.g., cyclohexynyl).

As used herein, when a definition is not otherwise provided, the prefix “halo” may refer to a group or compound including one more of a fluoro, chloro, bromo, iodo, and astatino substituent. A combination of different halo groups (e.g., bromo and fluoro) can be present.

As used herein, when a definition is not otherwise provided, the prefix “hetero” may refer to a compound or group that includes at least one a heteroatom (e.g., 1, 2, or 3 heteroatom(s)), wherein the heteroatom(s) is each independently N, O, S, Si, or P.

As used herein, when a definition is not otherwise provided, “heteroaryl” may refer to a monovalent carbocyclic ring group that includes one or more aromatic rings, in which at least one ring member (e.g., one, two or three ring members) is a heteroatom. In a C3 to C30 heteroaryl, the total number of ring carbon atoms ranges from 3 to 30, with remaining ring atoms being heteroatoms. Multiple rings, if present, may be pendent, spiro or fused. The heteroatom(s) are generally independently nitrogen (N), oxygen (O), P (phosphorus), or sulfur (S).

As used herein, when a definition is not otherwise provided, a “(meth)acryloyl group” is inclusive of an acryloyl group (H₂C═CH—C(═O)—) or a methacryloyl group (H₂C═C(CH₃)—C(═O)—)

As used herein, when a definition is not otherwise provided, “substituted” may refer to a compound or group that is substituted with at least one (e.g., 1, 2, 3, or 4) substituent, and the substituents are independently a hydroxyl (—OH), a C1-9 alkoxy, a C1-9 haloalkoxy, an oxo (═O), a nitro (—NO₂), a cyano (—CN), an amino (—NH₂), an azido (—N₃), an amidino (—O(═NH)NH₂), a hydrazino (—NHNH₂), a hydrazono (═N—NH₂), a carbonyl (—C(═O)—), a carbamoyl group (—C(O)NH₂), a sulfonyl (—S(═O)₂—), a thiol (—SH), a thiocyano (—SCN), a tosyl (CH₃C₆H₄SO₂—), a carboxylic acid (—O(═O)OH), a carboxylic C1 to C6 alkyl ester (—C(═O)OR wherein R is a 01 to C6 alkyl group), a carboxylic acid salt (—C(═O)OM) wherein M is an organic or inorganic anion, a sulfonic acid (—SO₃H₂), a sulfonic mono- or dibasic salt (—SO₃MH or —SO₃M₂ wherein M is an organic or inorganic anion), a phosphoric acid (—PO₃H₂), a phosphoric acid mono- or dibasic salt (—PO₃MH or —PO₃M₂ wherein M is an organic or inorganic anion), a C1 to C12 alkyl, a C3 to C12 cycloalkyl, a C2 to C12 alkenyl, a C5 to C12 cycloalkenyl, a C2 to C12 alkynyl, a C6 to C12 aryl, a C7 to C13 arylalkylene, a C4 to C12 heterocycloalkyl, or a C3 to C12 heteroaryl instead of hydrogen, provided that the substituted atom's normal valence is not exceeded. The indicated number of carbon atoms for any group herein is exclusive of any substituents.

At least one battery system may supply a part of or all of the motive power to an electric vehicle (EV). The electric vehicle may discharge less emissions and less environmental contamination material compared to a vehicle operated by an internal combustion engine, and may exhibit higher fuel efficiency. Some electric vehicles using electricity may use no gasoline at all and instead may be motive powered entirely from electricity. A demand for an improved electric power source, for example, an improved battery or battery module, for example, for electric vehicles, may increase.

A rechargeable lithium battery capable of being charged and discharged and having high energy density is of present interest, and is considered for use as an electrochemical device to provide motive power to electric vehicles.

A rechargeable lithium battery may be operated at an increased temperature and may be susceptible to moisture incursion. To prevent moisture incursion and performance degradation, an aluminum case material having a defined moisture transmission resistivity may be used to house a rechargeable lithium battery. For example, an electrode assembly including positive and negative electrodes may be inserted into a case such as an aluminum pouch, and then into an aluminum can and sealed to make a battery cell, and a plurality of the battery cells may be used to form a battery module. Such a production process can result in a complicated assembly process, e.g., lengthy fabrication times, and high cost, and there remains interest to improve the assembly process.

Since the shape of a battery case formed of a metal may be limited due to, for example, a limit in terms of metal manufacturing technology, a battery case having a desired shape, size, or a combination thereof may be made by a multistep process, having a relatively high cost and long manufacturing time.

In order to solve the above problems, a battery case may be made using a polymer material, which is light in weight and easily manufactured into a desired shape. However, in case of a battery case using a polymer material, moisture transmission resistivity and mechanical strength may have to be increased. In addition, internal heat inside the battery case is desirably efficiently discharged to outside of the battery case as the rechargeable lithium batteries may be operated at a high temperature. Different from a metal case, such as aluminum, which may have an acceptable or desirable level of flame retardancy, flame retardancy and heat dissipation properties may need to be provided to a battery case manufactured from a polymer matrix.

Simultaneously improving heat dissipation, moisture transmission resistivity, flame retardancy, mechanical properties, and the like, or a combination thereof of a polymer material may be difficult, as well as lower costs of manufacture; providing good processability for desired shape, size, and the like, or a combination thereof; or a combination thereof.

The present inventors have surprisingly discovered organic/inorganic composite materials that improve moisture transmission resistivity, mechanical properties, thermal conductivity, and flame retardancy simultaneously based on light and low-cost polymer resins, which may be easily formed into desired sizes and shapes. A composite including a polymer matrix, a carbon-based support (i.e., a carbonaceous support), and an inorganic moisture absorber, e.g., a nano-size inorganic moisture absorber, supported on the carbon-based support, which is dispersed in the polymer matrix, may realize, e.g., provide, the aforementioned effects.

As a method for increasing moisture transmission resistivity of materials based on polymer resins, an inorganic moisture absorber may be dispersed in a polymer matrix to form an organic/inorganic composite. Performance of the inorganic moisture absorber may be proportional to a specific surface area of the inorganic moisture absorber. An inorganic moisture absorber having a small particle size, such as a nano-size, may improve moisture transmission resistivity greater than an inorganic moisture absorber having a larger particle size. However, in a process of manufacturing an article by mixing a nano-sized inorganic moisture absorber with a polymer resin and then extruding the mixture, injecting the mixture, or injecting and extruding the mixture a viscosity of the polymer resin may become higher as the temperature increases, and it may be difficult to uniformly disperse the nano-sized inorganic moisture absorber particles in the polymer resin having high viscosity. The nano-sized inorganic moisture absorber in a manufactured article may not be uniformly dispersed in the polymer matrix and may exist in an aggregate form. The inorganic moisture absorber existing in an aggregate form may not exhibit an effect of improving the moisture transmission resistivity due to, for example, the increase in specific surface area that may be provided by a nano-sized inorganic moisture absorber.

In order to improve the heat dissipation properties of materials based on polymer resins, a composite may include a thermally conductive inorganic filler. A carbon-based material (i.e., a carbonaceous material) such as carbon black, ketjen black, graphite, expanded graphite, a carbon fiber, a carbon nanoplate, or a combination thereof may be used as the thermally conductive inorganic filler. These thermally conductive inorganic fillers may be used as phonon carriers in the polymer matrix to release heat from the polymer resin to outside of the polymer matrix. Therefore, the thermally conductive inorganic filler may be present in a sufficient amount to form a heat transfer path in the polymer matrix, and increasing a particle size of the thermally conductive inorganic filler may provide advantageous results.

The present inventors have discovered that inorganic moisture absorbers, e.g., nano-sized inorganic moisture absorbers, may improve the moisture transmission resistivity of polymer materials, provided that the inorganic moisture absorbers, e.g., nano-sized inorganic moisture absorbers, are supported on the thermal conductive inorganic fillers such that the inorganic moisture absorbers may not aggregate and may have improved dispersibility, for example, by maintaining a nano-size. The thermal conductive inorganic filler, for example, a carbonaceous material may have a variety of shapes, and may have a large specific surface area. For example, carbon black, a known carbonaceous material, may form aggregates with a size of greater than or equal to about 0.1 micrometers by hard aggregation of primary spherically shaped carbon particles, e.g., nano-sized primary spherically shaped carbon particles. Aggregates may be formed by aggregating primary spherically shaped particles, e.g., nano-sized primary spherically shaped particles, in an irregular form and may have a large specific surface area. By adsorbing a precursor of the inorganic moisture absorber on the surface of the carbon-based material having a large specific surface area and then converting the adsorbed precursor of the inorganic moisture absorber into an inorganic moisture absorber, a carbon-based support containing an inorganic moisture absorber supported on the surface of the carbon-based material may be manufactured. The carbonaceous support on which the inorganic moisture absorber, e.g., nano-sized inorganic moisture absorber, is supported may have a D₅₀ particle diameter of greater than or equal to about 0.1 micrometers as the aforementioned aggregate form, and dispersion of the materials having such a size in the polymer resin may be improved.

The composite according to an embodiment may include a nano-sized inorganic moisture absorber, and the inorganic moisture absorber may be adsorbed on the surface of the carbonaceous support having a large particle size to be uniformly dispersed in the polymer matrix, whereby a moisture transmission resistivity effect of the nano-sized inorganic moisture absorber may be sufficiently exhibited. In addition, a large amount of the nano-sized inorganic moisture absorber may be included in proportion to the amount of the carbonaceous support, and the moisture transmission resistivity effect may be maximized. In addition, the composite may include aggregates having sizes of greater than or equal to about 0.1 micrometers of the carbonaceous supports, and the heat dissipation properties of the composite may be improved by forming phonon transfer paths in the polymer matrix through the aggregates. In addition, the carbonaceous supports themselves may have improved mechanical properties and may also increase mechanical properties of composites including the same.

Examples of the carbonaceous supports may include any suitable carbonaceous support such as carbonaceous inorganic fillers having thermal conductivity, and may be, for example, carbon black, ketjen black, graphite, expanded graphite, a carbon fiber, a carbon nanoplate, or a combination thereof, or in an embodiment, the carbonaceous support may include or be carbon black, but the carbonaceous support is not limited thereto.

As described above, the carbon black may have a shape of an aggregate of irregular primary carbon particles having a nano-sized spherical shape, but is not limited thereto. However, the carbonaceous support may have various shapes depending on the type. For example, the graphite may have a shape in which multiple sheets of carbon atoms extended in a two-dimensional planar form are laminated. The precursor of inorganic moisture absorber may penetrate into the space or surface between the laminates to be adsorbed and supported on the sheet surfaces of the laminates. Expanded graphite is a graphite including components such as oxygen between each layer of the graphite by being treated with strong acid, such as sulfuric acid, and may form a support on the same principle as the graphite. The carbonaceous supports may have different shapes depending on the types, but may have any suitable shape or size, for example, a wide surface area, and a size capable of adsorbing and being penetrated by the precursor of the inorganic moisture absorber, and the carbonaceous supports may have a high thermal conductivity.

In an embodiment, the carbonaceous supports may have a specific surface area of greater than or equal to about 100 m²/g, and include an aggregate of a D₅₀ particle diameter of greater than or equal to about 0.1 micrometers. When the carbonaceous supports have a specific surface area of greater than or equal to about 100 m²/g, the inorganic moisture absorber, e.g., nano-sized inorganic moisture absorber, may be supported in a sufficient amount on a wide surface of the carbonaceous support. In addition, when the aggregates of the carbonaceous supports have a D₅₀ particle diameter of greater than or equal to about 0.1 micrometers, the aggregates of the carbonaceous supports may be easily dispersed when mixed with the polymer resin and applied to, e.g., used in, an extrusion process, an injection process, or a combination hereof, and advantageously form a phonon transfer path in the polymer matrix.

In an embodiment, the carbonaceous supports may have a specific surface area of greater than or equal to about 100 m²/g, for example, greater than or equal to about 200 m²/g, greater than or equal to about 300 m²/g, greater than or equal to about 400 m²/g, greater than or equal to about 500 m²/g, greater than or equal to about 600 m²/g, greater than or equal to about 700 m²/g, greater than or equal to about 800 m²/g, greater than or equal to about 900 m²/g, greater than or equal to about 1,000 m²/g, greater than or equal to about 1,010 m²/g, greater than or equal to about 1,030 m²/g, greater than or equal to about 1,050 m²/g, greater than or equal to about 1,100 m²/g, greater than or equal to about 1,150 m²/g, greater than or equal to about 1,200 m²/g, greater than or equal to about 1,250 m²/g, greater than or equal to about 1,300 m²/g, greater than or equal to about 1,350 m²/g, greater than or equal to about 1,400 m²/g, greater than or equal to about 1,450 m²/g, or greater than or equal to about 1,500 m²/g, but are not limited thereto.

In an embodiment, the D₅₀ particle diameter of the aggregate of the carbonaceous support may be greater than or equal to about 0.11 micrometers, for example, greater than or equal to about 0.12 micrometers, greater than or equal to about 0.13 micrometers, greater than or equal to about 0.15 micrometers, greater than or equal to about 0.17 micrometers, greater than or equal to about 0.20 micrometers, greater than or equal to about 0.25 micrometers, greater than or equal to about 0.30 micrometers, greater than or equal to about 0.35 micrometers, greater than or equal to about 0.40 micrometers, greater than or equal to about 0.45 micrometers, greater than or equal to about 0.50 micrometers, greater than or equal to about 0.55 micrometers, greater than or equal to about 0.60 micrometers, greater than or equal to about 0.70 micrometers, greater than or equal to about 0.80 micrometers, greater than or equal to about 0.90 micrometers, greater than or equal to about 1.00 micrometer, greater than or equal to about 1.10 micrometers, greater than or equal to about 1.20 micrometers, greater than or equal to about 1.30 micrometers, greater than or equal to about 1.40 micrometers, greater than or equal to about 1.50 micrometers, greater than or equal to about 1.60 micrometers, greater than or equal to about 1.70 micrometers, greater than or equal to about 1.80 micrometers, greater than or equal to about 1.90 micrometers, greater than or equal to about 2.0 micrometers, greater than or equal to about 2.1 micrometers, greater than or equal to about 2.2 micrometers, greater than or equal to about 2.3 micrometers, greater than or equal to about 2.4 micrometers, greater than or equal to about 2.5 micrometers, greater than or equal to about 2.6 micrometers, greater than or equal to about 2.7 micrometers, greater than or equal to about 2.8 micrometers, greater than or equal to about 2.9 micrometers, or greater than or equal to about 3.0 micrometers, but is not limited thereto. In an embodiment, the D₅₀ particle diameter of the aggregate of the carbonaceous support may be less than or equal to about 100 micrometers, for example, less than or equal to about 90 micrometers, less than or equal to about 80 micrometers, less than or equal to about 70 micrometers, less than or equal to about 60 micrometers, less than or equal to about 50 micrometers, less than or equal to about 40 micrometers, less than or equal to about 30 micrometers, less than or equal to about 20 micrometers, or less than or equal to about 10 micrometers, but is not limited thereto.

The inorganic moisture absorber may include silica gel, zeolite, CaO, BaO, MgSO₄, Mn(ClO₄)₂, MgO, P₂O₅, Al₂O₃, CaH₂, NAH, LiAlH, CaSO₄, Na₂SO₄, Na₂CO₃, CaCO₃, K₂CO₃, CaCl₂), Ba(ClO₄)₂, Ca, or a combination thereof.

In an embodiment, the inorganic moisture absorber may include zeolite, CaO, MgO, or a combination thereof, and for example, the inorganic moisture absorber may be CaO or MgO.

The particle size of the inorganic moisture absorber may be a D₅₀ particle diameter of greater than or equal to about 5 nm and less than about 1 micrometer, for example, about 10 nm to about 950 nm, about 10 nm to about 900 nm, about 10 nm to about 850 nm, about 10 nm to about 800 nm, about 10 nm to about 750 nm, about 10 nm to about 700 nm, about 10 nm to about 650 nm, about 10 nm to about 600 nm, about 10 nm to about 550 nm, about 10 nm to about 500 nm, about 20 nm to about 500 nm, about 20 nm to about 450 nm, about 20 nm to about 400 nm, about 20 nm to about 350 nm, about 20 nm to about 300 nm, about 20 nm to about 250 nm, about 20 nm to about 200 nm, about 20 nm to about 150 nm, about 20 nm to about 100 nm, about 30 nm to about 300 nm, about 30 nm to about 250 nm, about 30 nm to about 200 nm, about 30 nm to about 150 nm, about 30 nm to about 100 nm, about 30 nm to about 80 nm, or about 30 nm to about 50 nm, but is not limited thereto.

A method of supporting the inorganic moisture absorber on the carbonaceous support may include dissolving the precursor of the inorganic moisture absorber in an organic solvent, dispersing the carbonaceous support in the solution such that the precursor of the inorganic moisture absorber may be adsorbed on the surface of the carbonaceous support, then, separating a carbonaceous support on which the precursor of the inorganic moisture absorber is adsorbed from the solution and evaporating the solvent, and converting the precursor of the inorganic moisture absorber adsorbed on the carbonaceous support into an inorganic moisture absorber, e.g., a nano-sized inorganic moisture absorber, through an additional heat treatment.

Various precursors may be used depending on the type of inorganic moisture absorber. For example, when the inorganic moisture absorber is CaO, a precursor of the CaO may be calcium nitrate, calcium acetate, calcium propionate, calcium formate, calcium oxalate, calcium acetylacetonate, and the like, or a combination thereof, and when the inorganic moisture absorber is MgO, magnesium chloride, magnesium chloride hydrate, magnesium acetate, and the like, or a combination thereof may be used, but are not limited thereto.

The precursor of the inorganic moisture absorber may be dissolved in various organic solvents, for example, alcohol based solvents, such as, ethanol, propanol, and isopropanol, aromatic solvents such as toluene, acetate based solvents, such as, ethyl acetate, and ketone based solvents, such as, acetone, in appropriate amount. Here, an amount of the inorganic moisture absorber supported on the carbonaceous support may be controlled according to an amount of the precursor of the inorganic moisture absorber dissolved in the organic solvent. That is, the greater the amount of the precursor of the inorganic moisture absorber in the solvent, the greater the amount of the inorganic moisture absorber supported on the carbonaceous support produced therefrom.

A nano-sized inorganic moisture absorber may be supported on the carbonaceous support by dispersing the carbonaceous support, for example, the aforementioned carbon black, ketjen black, graphite, expanded graphite, carbon fiber, a carbon nanoplate, or a combination thereof in the solution to absorb the precursor of the inorganic moisture absorber on the surface of the carbonaceous support, separating the carbonaceous support on which the precursor of the inorganic moisture absorber is adsorbed and evaporating a solvent, and converting the adsorbed precursor of the inorganic moisture absorber into the inorganic moisture absorber through an additional heat treatment.

A total amount of the carbonaceous support and the inorganic moisture absorber supported on the carbonaceous support in the composite according to an embodiment may be greater than or equal to about 5%, for example, greater than or equal to about 7%, greater than or equal to about 10%, greater than or equal to about 11%, greater than or equal to about 13%, greater than or equal to about 15%, greater than or equal to about 17%, greater than or equal to about 18%, greater than or equal to about 20%, greater than or equal to about 21%, greater than or equal to about 22%, greater than or equal to about 23%, greater than or equal to about 24%, or greater than or equal to about 25%, based on a total weight of the composite, but is not limited thereto. In an embodiment, a total amount of the carbonaceous support and the inorganic moisture absorber supported on the carbonaceous support may be less than or equal to about 30%, for example, less than or equal to about 29%, less than or equal to about 28%, less than or equal to about 27%, or less than or equal to about 26%, for example, within the ranges about 8% to about 30%, for example, about 10% to about 30%, about 10% to about 28%, about 10% to about 25%, about 10% to about 23%, about 10% to about 22%, about 10% to about 20%, about 13% to about 20%, or about 15% to about 20%, based on a total weight of the composite, but is not limited thereto. The composite according to an embodiment may have excellent moisture transmission resistivity, mechanical properties, and thermal conductivity by including the carbonaceous support and the inorganic moisture absorber supported thereon within the disclosed amount ranges, based on a total weight of the composite.

The amount of inorganic moisture absorber supported on the carbonaceous support may be about 3% to about 50%, based on a total weight of the carbonaceous support. For example, the inorganic moisture absorber may be included in an amount of about 5% to about 50%, about 8% to about 50%, about 10% to about 50%, about 10% to about 45%, about 10% to about 40%, about 10% to about 35%, about 10% to about 30%, about 15% to about 35%, about 15% to about 30%, about 15% to about 25%, about 15% to about 20%, about 17% to about 30%, about 17% to about 25%, or about 17% to about 20%, based on a total weight of the carbonaceous support, but is not limited thereto. By including the inorganic moisture absorber within the disclosed amount ranges relative to the total weight of the carbonaceous support in the composite, the composite according to an embodiment may have excellent moisture transmission resistivity, mechanical properties, and thermal conductivity.

As described above, the amount of inorganic moisture absorber supported on the carbonaceous support may be controlled by the amount of the inorganic moisture absorber precursor dissolved in the organic solvent during the process to support the inorganic moisture absorber on the carbonaceous support. That is, the greater the amount of the precursor of the inorganic moisture absorber in the solution including precursor of the inorganic moisture absorber, the greater the amount of inorganic moisture absorber supported on the carbonaceous support.

The polymer matrix included in the composite may include any suitable type of polymers with desirable moisture transmission resistivity and mechanical strength, and may be easily molded, but may include for example, a polycarbonate, a polyolefin, a polyvinyl, a polyamide, a polyester, a polyphenylene sulfide (PPS), a polyphenylene ether, a polyphenylene oxide, a polystyrene, a polyamide, a polycyclic olefin copolymer, an acrylonitrile-butadiene-styrene copolymer, a liquid crystal polymer (LCP), or a copolymer thereof, or a combination thereof. For example, the polymer matrix may include or be a liquid crystal polymer (LCP) with excellent moisture transmission resistivity, or a low-cost polyolefin with excellent mechanical properties, and in an embodiment, the polymer matrix may include or be a polyolefin, for example, a high density polyethylene (HDPE).

In an embodiment, the polymer matrix may further include a fluorinated resin. Examples of the fluorinated resin may include polytetrafluoroethylene (PTFE), polyvinylidene fluoride (PVDF), polychlorotrifluoroethylene (PCTFE), copolymers thereof, or a combination thereof. When the polymer matrix further includes such a fluorinated resin, moisture transmission resistivity of the composite manufactured therefrom may be further increased.

The fluorinated resin may have desirable hydrophobicity, and when the fluorinated resin is included in an amount of less than or equal to about 20%, less than or equal to about 15%, less than or equal to about 10%, for example, about 3% to about 10%, or about 5% to about 10%, based on a total weight of the composite, an article made from the composite including the same may block moisture from the surface of the article that is in contact with outside air, for example, from being transmitted through the polymer matrix.

The composite according to an embodiment may further include an oligomer or a polymer dissolvable in a solvent having a solubility parameter of about 15 MPa^{1/2} to about 30 MPa^{1/2} and including an amino group, a hydrophobic functional group, an amphiphilic functional group, or a combination thereof. When the composite further includes the oligomer or polymer as described above, mechanical properties, for example, tensile strength and impact strength of the articles manufactured therefrom may further be improved. The oligomer or polymer dissolvable in a solvent having the solubility parameter of about 15 MPa^{1/2} to about 30 MPa^{1/2} and including an amino group, a hydrophobic functional group, an amphiphilic functional group, or a combination thereof may be a material having affinity for both the polymer matrix and the carbonaceous support in the composite according to the embodiment and may improve dispersion of the carbonaceous support in the polymer matrix. For example, the oligomer or polymer dissolvable in a solvent having the solubility parameter of about 15 MPa^{1/2} to about 30 MPa^{1/2} and including an amino group, a hydrophobic functional group, an amphiphilic functional group, or a combination thereof may be well-mixed with both the polymer matrix and the carbonaceous support in the presence of the solvent or even without the presence of the solvent. As the oligomer or polymer includes an amino group, a hydrophobic functional group, an amphiphilic functional group, or a combination thereof, the oligomer or polymer may be well-adsorbed on the surface of the carbonaceous support.

Without being bound to specific theory, it is understood that the oligomer or polymer being absorbed on the surface of the carbonaceous support is caused by a non-covalent bond with the carbonaceous support by a lone pair electrons of a nitrogen atom of an amino group of the oligomer or polymer, a Van der Waals bond caused by forming a hydrophobic block between a hydrophobic functional group of the oligomer or polymer and the carbonaceous support, a pi (Π)-electron bond (stacking) caused by a physical absorption, or a chemical bond between one of the amphiphilic functional groups and a functional group, such as, a carboxyl group, a hydroxy group, and the like, or a combination thereof, on the surface of the carbonaceous support, but is not limited thereto.

The oligomer or polymer may be bonded to or absorbed on the surface of the carbonaceous support by the various available mechanisms and also well-mixed with the polymer matrix, so ultimately, the polymer matrix and the carbonaceous support may be further well-mixed and bonded in the composite. The composite further including the oligomer or polymer may further improve mechanical properties, such as tensile strength and impact strength, when molding the same, and also may further enhance thermal conductivity.

When the composite according to an embodiment further includes the oligomer or polymer, the composite including the same may be prepared by supporting an inorganic moisture absorber on the carbonaceous support, preliminarily mixing the same with the oligomer or polymer to bond or to absorb the oligomer or polymer on a surface of the carbonaceous support before mixing the same with the polymer matrix, and finally mixing the carbonaceous support surface-treated with the oligomer or polymer with the polymer matrix. The composite may be prepared in-situ by simultaneously mixing the polymer matrix, the carbonaceous support supported with the inorganic moisture absorber, and the oligomer or polymer. In an embodiment, preparation of the composite may include the preliminarily mixing the inorganic moisture absorber-supported carbonaceous support with the oligomer or polymer before mixing the polymer matrix, and the oligomer or polymer may be more effectively bonded to or adsorbed with, for example, on, the carbonaceous support. The oligomer or polymer may be called a surface-treating agent of the inorganic moisture absorber-supported carbonaceous support.

When the oligomer or polymer includes an amino group, an amine value of the oligomer or polymer may range from about 1 mg KOH/g to about 100 mg KOH/g. When the amine value, which means a content of amino groups in the oligomer or polymer, is in the range of from about 1 mg KOH/g to about 100 mg KOH/g, the oligomer or polymer may easily adsorb or bind to the carbonaceous support.

In an embodiment, the amine value of the oligomer or polymer may be about 1 mg KOH/g to about 90 mg KOH/g, for example, about 2 mg KOH/g to about 80 mg KOH/g, about 3 mg KOH/g to about 80 mg KOH/g, about 3 mg KOH/g to about 75 mg KOH/g about 3 mg KOH/g to about 70 mg KOH/g, about 3 mg KOH/g to about 65 mg KOH/g, about 3 mg KOH/g to about 60 mg KOH/g, about 4 mg KOH/g to about 80 mg KOH/g, about 4 mg KOH/g to about 75 mg KOH/g, about 4 mg KOH/g to about 70 mg KOH/g, about 4 mg KOH/g to about 65 mg KOH/g, about 4 mg KOH/g to about 60 mg KOH/g, about 4 mg KOH/g to about 58 mg KOH/g, or about 4 mg KOH/g to about 57 mg KOH/g, but is not limited thereto. The oligomer or polymer may be selected or prepared with a suitable amine value in order to produce a composite according to an embodiment.

The hydrophobic functional group of the oligomer or polymer may be any suitable organic group having hydrophobicity and may be, for example, an aliphatic hydrocarbon group, an alicyclic hydrocarbon group, an aromatic hydrocarbon group, a (meth)acryloyl group, a halogen-substituted aliphatic hydrocarbon group, alicyclic hydrocarbon group, or a combination thereof, for example, a group having at least one unsaturated bond in the molecule.

Examples of the hydrophobic functional group may be a linear or branched C1 to C30 alkyl group, a C3 to C30 cycloalkyl group, a C2 to C30 alkenyl group including at least one double bond, a C2 to C30 alkynyl group having at least one triple bond, a C6 to C30 aryl group, a C7 to C30 arylalkyl group, a C7 to C30 alkylaryl group, a 010 to C30 cycloalkylaryl group, a (meth)acryloyl group, a fluorinated alkyl group, a fluorinated cycloalkyl group, a fluorinated aryl group, or a combination, but are not limited thereto.

The amphiphilic functional group of the oligomer or polymer may be a functional group having both an anionic functional group and a cationic functional group wherein for example, the cationic functional group may be an ammonium group, an imidazole group, a sulfonium group, or a combination thereof, and the anionic functional group may be a phosphonium group, a carboxyl group, a silane group, or a combination thereof.

The oligomer or polymer may be included in an amount of less than or equal to about 50 parts by weight per 100 parts by weight of the carbonaceous support. For example, the oligomer or polymer may be included in an amount of less than or equal to about 45 parts by weight, less than or equal to about 40 parts by weight, less than or equal to about 35 parts by weight, for example, about 10 parts by weight to about 50 parts by weight, about 15 parts by weight to about 50 parts by weight, about 20 parts by weight to about 50 parts by weight, about 25 parts by weight to about 50 parts by weight, about 25 parts by weight to about 45 parts by weight, about 25 parts by weight to about 40 parts by weight, about 25 parts by weight to about 35 parts by weight, about 25 parts by weight to about 30 parts by weight per 100 parts by weight of the carbonaceous support, but is not limited thereto. The amount of the oligomer or polymer may be appropriately selected and adjusted, taking into consideration types and contents of the carbonaceous support and types of the oligomer or polymer, types, amount, or a combination thereof of the functional groups contained in the oligomer or polymer, or a combination thereof.

The amount of the polymer matrix in the composite is a remainder of the composite excluding the amount of the carbonaceous support and the inorganic moisture absorber supported on the carbonaceous support, and, if present, the amount of the oligomer or polymer dissolvable in a solvent having a solubility parameter of about 15 MPa^{1/2} to about 30 MPa^{1/2} and including an amino group, a hydrophobic functional group, an amphiphilic functional group, or a combination thereof, based on a total weight of the composite. For example, an amount of the polymer matrix may be, about 50% to about 95%, about 55% to about 95%, about 60% to about 95%, about 65% to about 95%, about 70% to about 95%, about 75% to about 95%, about 75% to about 90%, about 75% to about 85%, about 80% to about 95%, about 80% to about 90%, or about 85% to about 90%, based on a total weight of the composite, but is not limited thereto. In the composite according to an embodiment, by controlling types and amount of the polymer matrix, types and amount of the carbonaceous support, and types and amount of the inorganic moisture absorber, e.g., nano-sized inorganic moisture absorber, supported on the carbonaceous support, an article molded to have a thickness of 1 mm may have a decreased water vapor transmission rate (WVTR) up to less than about 0.4 g/m²/day, for example, less than or equal to about 0.3 g/m²/day, less than or equal to about 0.2 g/m²/day, less than or equal to about 0.1 g/m²/day, less than or equal to about 0.09 g/m²/day, less than or equal to about 0.08 g/m²/day, less than or equal to about 0.07 g/m²/day, less than or equal to about 0.06 g/m²/day, less than or equal to about 0.05 g/m²/day, less than or equal to about 0.045 g/m²/day, less than or equal to about 0.04 g/m²/day, less than or equal to about 0.035 g/m²/day, less than or equal to about 0.03 g/m²/day, less than or equal to about 0.025 g/m²/day, less than or equal to about 0.02 g/m²/day, less than or equal to about 0.015 g/m²/day, or less than or equal to about 0.01 g/m²/day, measured at 38° C. under relative humidity of 100% according to ISO 15106, which may be decreased to more low level.

In addition, the article may have a tensile strength of greater than or equal to about 350 kg/cm², for example, greater than or equal to about 380 kg/cm², greater than or equal to about 400 kg/cm², greater than or equal to about 410 kg/cm², greater than or equal to about 420 kg/cm², greater than or equal to about 430 kg/cm², greater than or equal to about 440 kg/cm², greater than or equal to about 450 kg/cm², greater than or equal to about 460 kg/cm², or greater than or equal to about 470 kg/cm², measured using UTM (Universal Testing Machine) according to ASTM D₆₃₈, but is not limited thereto.

Furthermore, according to the results of measuring the articles for un-notched type Izod impact strength by Instron (impactor II, CEAST 9050) according to ASTM D₂₆₅, the article may be unbreakable, or may have impact strength of at least greater than or equal to about 60 kilojoules per square meter (kJ/m²), greater than or equal to about 65 kJ/m², greater than or equal to about 70 kJ/m², greater than or equal to about 75 kJ/m², greater than or equal to about 80 kJ/m², greater than or equal to about 85 kJ/m², greater than or equal to about 90 kJ/m², greater than or equal to about 95 kJ/m², or greater than or equal to about 97 kJ/m².

In addition, the article may have a thermal conductivity in a vertical direction and a horizontal direction, which is measured by a laser flash method, each greater than or equal to about 0.3 watts per meter-Kelvin (W/mK), each greater than or equal to about 0.4 W/mK, each greater than or equal to about 0.45 W/mK, each greater than or equal to about 0.5 W/mK, each greater than or equal to about 0.55 W/mK, each greater than or equal to about 0.6 W/mK, each greater than or equal to about 0.65 W/mK, each greater than or equal to about 0.7 W/mK, each greater than or equal to about 0.75 W/mK, or each greater than or equal to about 0.8 W/mK, and may not be limited thereto.

The article manufactured from the composite according to an embodiment may have a water vapor transmission rate as disclosed above, which is similar to the water vapor transmission rate of a metal pouch-formed exterior material wrapping the electrode assembly for the rechargeable lithium battery. When an article, such as, a battery case, is manufactured from the composite according to an embodiment, a cell-module integrated battery may be obtained by directly introducing an electrode assembly of the battery into space for accommodating the same without wrapping a separately provided electrode assembly with an additional exterior material such as a metal pouch. An embodiment provides a battery case including the composite according to an embodiment.

The battery case according to an embodiment may include a container configured to accommodate an electrode assembly, wherein the container includes a bottom wall and a plurality of side walls, the bottom wall and the side walls are integrated to have an open side opposed to the bottom wall and to provide a space for accommodating the electrode assembly, and the bottom wall, a side wall, e.g., a plurality of side walls, or a combination thereof includes the composite according to an embodiment.

In an embodiment, both the bottom wall and a side wall, e.g., a plurality of side walls, of the battery case of the container may include the composite according to an embodiment.

The container may include at least one partition wall within the space, which may partition the space within the container into two or more sections. Separately manufactured electrode assemblies may be accommodated into each of the two or more sections. As described above, the article obtained from the composite according to an embodiment may have excellent moisture transmission resistivity and mechanical properties, and thus an electrode assembly may be accommodated in at least two spaces of the container in the battery case according to an embodiment, by itself, without wrapping the separately manufactured electrode assembly with an additional metal pouch or the like. In an embodiment, a plurality of electrode assemblies may be accommodated directly in each space in the container of the battery case without packing each of them into a separate cell, and a cell-module integrated battery including a plurality of electrode assemblies may be easily manufactured.

An electrode assembly may be formed to include a positive electrode and a negative electrode, and then may be wrapped with a metal pouch having moisture transmission resistivity to provide a battery cell, and the battery cell may be packed with a metallic battery case to provide a battery module. Such a process may be complicated, may take a long time, and may involve high costs, and the obtained battery module has a considerable weight. The battery case obtained from the composite according to an embodiment may be easily manufactured into a cell-module integrated body, and the process cost and time may be decreased compared with a metallic battery case, and the weight of the battery case obtained from the composite may be light, and a freedom of shape may be appropriately provided.

The battery case may be a battery case for a rechargeable lithium battery, but is not limited thereto, and may be a case for a battery that accommodates any suitable electrode assembly having desirable moisture transmission resistivity, mechanical properties, and heat dissipation properties.

The battery case may further include, for example, a lid configured to cover at least one part of the open side of the container and having a positive terminal, a negative terminal, or a combination thereof. The lid may have a positive terminal, a negative electrode terminal, or a combination thereof, for example, both the positive terminal and the negative electrode terminal, and the battery in the battery case may be electrically connected to outside, e.g., an exterior, of the battery case. The lid may include the same material as the container, or the lid may include a different material from the container.

Hereinafter, a battery case according to an embodiment is described with reference to the appended drawings.

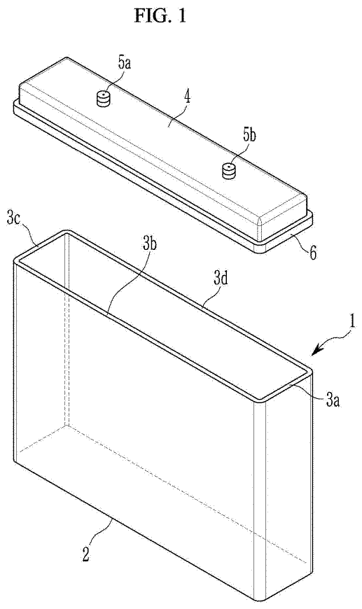

FIG. 1 is an exploded perspective view of a battery case according to an embodiment.

Referring to FIG. 1, a battery case according to an embodiment includes a container 1 including a bottom wall 2 and a plurality of (e.g., 3, 4, or greater) side walls 3a, 3b, 3c, and 3d that are integrated to provide a space for accommodating an electrode assembly. The container 1 has an open side opposed to the bottom wall 2 and an electrode assembly may be accommodated in the container 1 through the open side.

Herein, “integrated” indicates a state that the bottom wall is connected to a side wall, e.g., the plurality of side walls, and another side except for the open side, e.g., all the other sides except for the open side, provide one closed and sealed space. A method for integration is not particularly limited, but may include, for example, a method of molding the composite including a polymer matrix, a carbonaceous support, and an inorganic moisture absorber, e.g., a nano-sized inorganic moisture absorber, supported on the carbonaceous support, as described later, into a container having a space for accommodating an electrode assembly by integrating the bottom wall with a side wall, e.g., the plurality of side walls, or a method of separately molding the bottom wall and a side wall, e.g., the plurality of side walls, and then, connecting them in a method, such as, for example, welding, boning, or a combination thereof. As described above, the method for integration is not limited to a particular method, but may include various methods through which a container of a battery case may be fabricated to have a space for accommodating an electrode assembly by integrating the bottom wall and a side wall, e.g., the plurality of side walls.

The battery case may further include a lid 4 to cover, for example, seal, at least one part, for example, a whole part, of the open side of the container 1. The lid 4 may have the positive terminal 5a, the negative terminal 5b, or a combination thereof (e.g., positive terminal and negative terminal). The lid 4 may include the same material as the container 1 or a different material from the container 1, and the battery case according to an embodiment may be entirely sealed by covering the open side of the container 1 with the lid 4 and sealing the same.

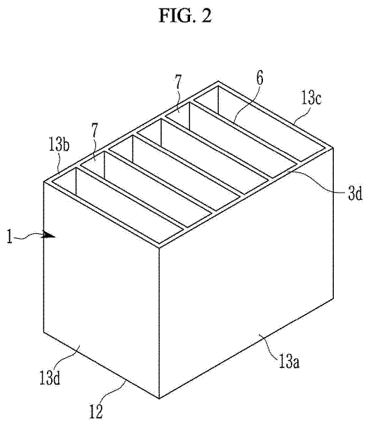

FIG. 2 is an exploded perspective view of a battery case according to an embodiment.

Referring to FIG. 2, a container 1 of a battery case according to an embodiment has a space formed by integrating a bottom wall 12 with a side wall, e.g., a plurality of side walls (e.g., 3, 4, or more) 13a, 13b, 13c, and 13d, and an open side facing the bottom wall 12, and in the space, at least one partition wall 6 (e.g., 2, 3, 4, 5, or more) is provided. The container may include a plurality of (e.g., greater than or equal to 2, for example, greater than or equal to 3, for example, greater than or equal to 4, or for example, greater than or equal to 5) battery cell compartment 7 defined by the partition wall 6. Each battery cell compartment 7 may include the electrode assembly that will be described below, and a battery module may be fabricated by accommodating at least two electrode assemblies in each battery cell compartment and injecting an electrolyte solution therein. After disposing the electrode assembly and injecting the electrolyte solution, the open side of the container 1 may be closed or sealed with a lid, which is not shown.

FIGS. 1 and 2 show the container 1 of the battery case having a rectangular parallelepiped, but the battery case according to an embodiment has no limit to the shape but may have various shapes and sizes.

An embodiment provides a battery including the battery case according to the embodiment and an electrode assembly accommodated in the container of the battery case and including a positive electrode and a negative electrode.

The battery case is the same as described above.

The electrode assembly may include a positive electrode, a negative electrode, and a separator disposed therebetween. The electrode assembly may further include, for example, an aqueous non-aqueous electrolyte solution in the separator. The types of the electrode assembly are not particularly limited. In an embodiment, the electrode assembly may include an electrode assembly for a rechargeable lithium battery. The positive electrode, the negative electrode, the separator, and the electrolyte solution of the electrode assembly may be appropriately selected taking into consideration types of the electrode and are not particularly limited. Hereinafter, the electrode assembly for a rechargeable lithium battery is exemplified, but the present disclosure is not limited thereto.

The positive electrode may include, for example, a positive active material disposed on a positive current collector, and may further include a conductive material, a binder, or a combination thereof. The positive electrode may further include a filler. The negative electrode may include, for example, a negative active material disposed on a negative current collector, and may further include a conductive material, a binder, or a combination thereof. The negative electrode may further include a filler.

The positive active material may include, for example, a (solid solution) oxide including lithium, but is not particularly limited, and the positive active material desirably includes a material capable of intercalating and deintercalating lithium ions electrochemically. The positive active material may be a layered compound, such as, lithium cobalt oxide (LiCoO₂), lithium nickel oxide (LiNiO₂), and the like, a compound substituted with one or more transition metal; a lithium manganese oxide such as chemical formulae Li₁₊ₓMn₂₋ₓO₄ (wherein, x is 0 to 0.33), LiMnO₃, LiMn₂O₃, LiMnO₂, and the like; lithium copper oxide (Li₂CuO₂), vanadium oxide such as LiV₃O₈, LiFe₃O₄, V₂O₅, Cu₂V₂O₇, and the like; a Ni site-type lithium nickel oxide represented by chemical formula LiNi₁₋ₓMₓO₂ (wherein, M=Co, Mn, Al, Cu, Fe, Mg, B, or Ga and x=0.01 to 0.3); a lithium manganese composite oxide represented by chemical formula LiMn₂₋ₓMₓO₂ (wherein, M=Co, Ni, Fe, Cr, Zn, or Ta and x=0.01 to 0.1) or Li₂Mn₃MO₈ (wherein, M=Fe, Co, Ni, Cu, or Zn); LiMn₂O₄ wherein a part of Li of chemical formula is substituted with an alkaline-earth metal ion; a disulfide compound; Fe₂ (MoO₄)₃; and the like; or a combination thereof, but is not limited thereto.

Examples of the conductive material may be carbon black, such as, ketjen black, acetylene black, and the like, natural graphite, artificial graphite, and the like, or a combination thereof, but is not particularly limited, and the conductive material desirably increases conductivity of the positive electrode.

The binder may include or be, for example, polyvinylidene fluoride, an ethylene-propylene-diene terpolymer, a styrene-butadiene rubber, an acrylonitrile-butadiene rubber, a fluorine rubber, a polyvinyl acetate, a polymethylmethacrylate, a polyethylene, a nitrocellulose, and the like, or a combination thereof, but is not particularly limited as long as it may bind the (positive or negative) active material and the conductive material on the current collector. Examples of the binder may be polyvinyl alcohol, carboxylmethyl cellulose (CMC), starch, hydroxypropyl cellulose, recycled cellulose, tetrafluoroethylene, a polyethylene, a polypropylene, an ethylene-propylene-diene polymer (EPDM), a sulfonated EPDM, a styrene-butene rubber, a fluorine rubber, various copolymers, a polymeric highly saponified polyvinyl alcohol, and the like, or a combination thereof in addition to the foregoing materials.

The negative active material may be for example, carbon and graphite materials, such as natural graphite, artificial graphite, expanded graphite, a carbon fiber, non-graphizable carbon, carbon black, carbon nanotube, fullerene, activated carbon, and the like; a metal such as Al, Si, Sn, Ag, Bi, Mg, Zn, In, Ge, Pb, Pd, Pt, Ti, and the like, which may be alloyed with lithium, and a compound including such an element; a composite material of a metal and a compound thereof and carbon and graphite materials; a lithium-containing nitride, and the like; or a combination thereof. Among them, carbon-based active materials, silicon-based active materials, tin-based active materials, or silicon-carbon-based active materials may be desirably used, and one or more carbon-based active materials may be used.

The separator is not particularly limited, and may be any suitable separator of a rechargeable lithium battery. For example, a porous film having excellent high rate discharge performance, a non-woven fabric having excellent high rate discharge performance, or a combination thereof may be used. The separator may include pores, and the pores may have generally a pore diameter of about 0.01 micrometers (μm) to about 10 μm, and a thickness of about 5 μm to about 300 μm. A substrate of the separator may include, for example, a polyolefin resin, a polyester resin, polyvinylidene fluoride (PVDF), a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, and the like, or a combination thereof. When the electrolyte is a solid electrolyte, such as a polymer, the solid electrolyte may function as a separator.

The conductive material is a component that further improves conductivity of an active material, and may be included in an amount of about 1 weight percent (wt %) to about 30 wt %, based on a total weight of the electrode, but is not limited thereto. Such a conductive material is not particularly limited, should not cause chemical changes of, e.g., in, a battery, may have desirable conductivity, and may be for example, graphite such as natural graphite or artificial graphite; carbon black such as carbon black, acetylene black, ketjen black, channel black, furnace black, lamp black, summer black, and the like; a carbon derivative such as carbon nanotube, fullerene, and the like, a conductive fiber such as a carbon fiber or a metal fiber, and the like; carbon fluoride, a metal powder such as aluminum, a nickel powder, and the like; a conductive whisker such as zinc oxide, potassium titanate, and the like; a conductive metal oxide such as a titanium oxide; a conductive material such as a polyphenylene derivative, and the like; or a combination thereof.

The filler is an auxiliary component that desirably suppresses expansion of an electrode, is not particularly limited, should not cause chemical changes of, e.g., in, a battery, may be a fiber-shaped material, and may be for example, an olefin polymer, such as a polyethylene, a polypropylene, and the like; a fiber-shaped material such as a glass fiber, a carbon fiber, and the like; or a combination thereof.

In the electrode, the current collector may be a site at which an electron transports in an electrochemical reaction of the active material and may be a negative current collector and a positive current collector according to types of the electrode. The negative current collector may have a thickness of about 3 μm to about 500 μm. The negative current collector is not particularly limited, should not cause chemical changes of, e.g., in, a battery, may have desirable conductivity and may be, for example, copper, stainless steel, aluminum, nickel, titanium, fired carbon, copper or stainless steel that is surface-treated with, for example, carbon, nickel, titanium, silver, or a combination thereof, an aluminum-cadmium alloy, or a combination thereof.

The positive current collector may have a thickness of about 3 μm to about 500 μm, but is not limited thereto. Such a positive current collector is not particularly limited, should not cause chemical changes of, e.g., in, a battery, may have high conductivity, and may be, for example, stainless steel, aluminum, nickel, titanium, fired carbon, aluminum or stainless steel that is surface-treated with, for example, carbon, nickel, titanium, silver, or a combination thereof, or a combination thereof.

The current collectors may have a fine concavo-convex on a surface thereof to reinforce a binding force of the active material, and may be used in various shapes such as a film, a sheet, a foil, a net, a porous film, a foam, a non-woven fabric, or the like.

The lithium-containing non-aqueous electrolyte solution may include, e.g., consist of, a non-aqueous electrolyte and a lithium salt.

The non-aqueous electrolyte may be, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydroxy franc, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and the like, or a combination thereof.

The lithium salt is a material that is desirably dissolved in the non-aqueous electrolyte solution, and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloro borane, a lower aliphatic lithium carbonate (e.g., an aliphatic lithium carbonate including less than or equal to about 10 carbon atoms), lithium tetraphenyl borate, lithium imide, and the like, or a combination thereof.

An organic solid electrolyte, an inorganic solid electrolyte, and the like, or a combination thereof may be used as desired.

The organic solid electrolyte may be, for example, a polyethylene derivative, a polyethylene oxide derivative, a polypropylene oxide derivative, a phosphoric acid ester polymer, a poly agitation lysine, a polyester sulfide, a polyvinyl alcohol, a polyvinylidene fluoride, a polymer including an ionic leaving group, and the like, or a combination thereof.

The inorganic solid electrolyte may be, for example, a nitride of Li such as Li₃N, LiI, Li₅NI₂, Li₃N—LiI—LiOH, Li₂SiS₃, Li₄SiO₄, Li₄SiO₄—LiI—LiOH, Li₃PO₄—Li₂S—SiS₂, and the like, a halide, a sulfate, and the like, or a combination thereof.

The non-aqueous electrolyte solution may include, for example, pyridine, triethylphosphite, triethanolamine, cyclic ether, ethylene diamine, n-glyme, hexa phosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride in order to improve charge and discharge characteristics, flame retardancy, and the like, or a combination thereof. As desired, in order to endow, e.g., impart, inflammability, a halogen-containing solvent, such as, carbon tetrachloride, ethylene trifluoride, and the like, may be further added, and in order to improve high temperature storage characteristics, carbon dioxide gas may be further added.

As described above, a battery including a battery case according to an embodiment may not include a unit cell, e.g., manufacture of a unit cell, including exterior materials including, e.g., consisting of, additional moisture transmission resistivity materials on each electrode assembly, and an electrode assembly accommodated in the container of the battery case may not include additional exterior materials.

A battery case according to an embodiment may be easily manufactured from the composite including the polymer matrix and the carbonaceous support on which the inorganic moisture absorber, e.g., nano-sized inorganic moisture absorber, is supported. For example, the composite in a form of a mixture including the polymer matrix and carbonaceous support on which the inorganic moisture absorber, e.g., nano-sized inorganic moisture absorber, is supported may be molded according to the various plastic molding methods, for example, extrusion molding, injection molding, blow molding, press molding, and the like, or a combination thereof, and a battery case having a desirable size and form according to an embodiment may be provided. An electrode assembly including a positive electrode and a negative electrode, which may be separately manufactured, may be accommodated in the battery case, and an electrolyte solution may be injected into and sealed in the battery container accommodating the electrode assembly to manufacture a battery according to an embodiment.

The battery fabricating method may not include packing an electrode assembly with a metal exterior material, and may include a simplified process for easily and fast fabricating a battery or a battery module. The battery case may be fabricated to include at least two battery cell compartments having a desired size with a desired number by forming at least one partition wall in the space of the battery container. A desired number of electrode assemblies having a desired size may be simply introduced into at least two battery cell compartments without being wrapped with an additional metal pouch and the like to easily fabricate a battery module including a desired number of an electrode assembly. Such a battery module may be lighter in terms of entire weight compared to a battery module including an additional metal pouch due to, for example, a lighter weight of the battery case and may exhibit improved energy efficiency.

Although the composite according to an embodiment includes a polymer matrix, a carbonaceous support, and an inorganic moisture absorber supported on the carbonaceous support, the composite is not limited thereto, but a composite including any suitable transparent support instead of the carbonaceous support may be equivalently applied.

The transparent support may include, for example, mesoporous silica, mesoporous amorphous silica, porous alumina, or a porous metal oxide configured to form a metal-organic framework (MOF), and a D₅₀ particle diameter of the inorganic moisture absorber supported on the transparent support may be less than or equal to about 40 nm.

When the composite according to an embodiment includes a transparent support instead of the carbonaceous support, and the inorganic moisture absorber supported on the transparent support has a D₅₀ particle diameter of less than or equal to about 40 nm, the article including the composite may be optically transparent. When the composite includes a transparent support, a sample of the composite having a thickness of 2.3 mm may have a light transmission of greater than 85%, or greater than 90%, or greater than 95%, or greater than 98%, as determined in accordance with ASTM D₁₀₀₃-15 (method B).

The transparent article may be suitably applied to, e.g., used in, an exterior case for a display device, for example, an organic light emitting diode (OLED).

Hereinafter, the embodiments are described with reference to examples and comparative examples. The following examples and comparative examples are exemplary but do not limit the scope of the present disclosure.

### EXAMPLES

### Synthesis Example 1: Manufacture of Carbon-Supported Magnesium Oxide (CSMO)

Hexahydrate of magnesium chloride (MgCl₂.6H₂O), which is as a precursor of an inorganic moisture absorber, is adsorbed on ketjen black EC-600JD (KB-600: manufactured by Mitsubishi; specific surface area: 1,270 square meters per gram (m²/g)) which is one type of carbon black as a carbon black support, dried, and fired to provide a magnesium oxide (MgO)-supported carbon black.

Specifically, each magnesium chloride hexahydrate (MgCl₂.6H₂O) is dissolved in ethanol in an amount of 5 parts by weight, 10 parts by weight, 15 parts by weight, 20 parts by weight, and 25 parts by weight, respectively, per 100 parts by weight of the carbon black, and each 100 parts by weight of ketjen black powder is added to the each solution and performed with ultrasonication for 15 minutes. Then, it is stirred for 5 hours so that hexahydrate of magnesium chloride is adsorbed on ketjen black, then magnesium chloride hexahydrate-supported ketjen black is separated from the solution.

The separated magnesium chloride hexahydrate-supported ketjen black is allowed to stand at 120° C. overnight to be completely dried. Then, it is heated to 420° C. under a nitrogen (N₂) atmosphere at a heating rate of 0.5° C./minute, fired by maintaining the temperature for 30 minutes, and then cooled to room temperature to provide a Carbon Supported Magnesium Oxide (CSMO).

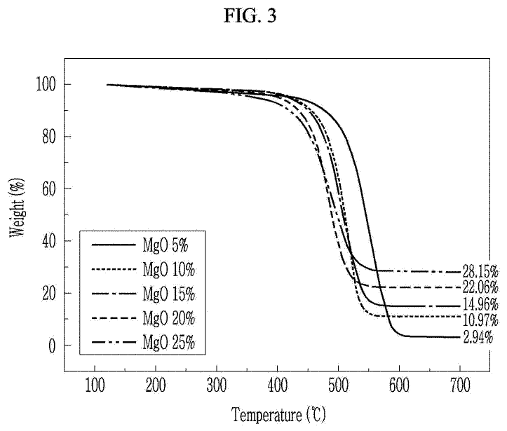

The obtained CSMO is measured using Discovery TGA (Thermogravimetric analysis) manufactured by TA Instruments while heating to 700° C., and the result graph is shown in FIG. 3. As understood from FIG. 3, carbon black is rapidly decomposed at a range from 400° C. to 600° C., and only magnesium oxide remained at the higher temperature. From the graph, it is confirmed that the amount of the residual magnesium oxide is proportional to a concentration of magnesium chloride hexahydrate used for preparing the CSMO.

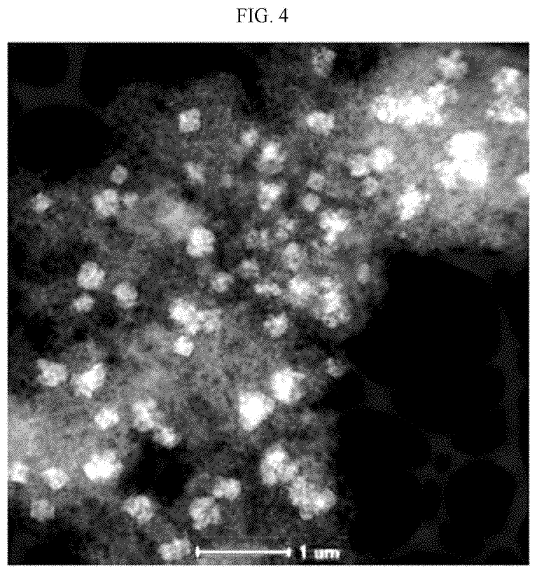

FIG. 4 is a TEM (Transmission Electron Microscopy) image of the obtained CSMO, showing that MgO particles having a size of about 50 nanometers (nm) to about 100 nm are uniformly supported on a surface of carbon black.

### Synthesis Example 2: Manufacture of Carbon Black Treated with Oligomer or Polymer

For each 10 grams (g) of CSMO obtained from Synthesis Example 1, each 0.5 g of (1) Disperbyk 2150 (amine value: 57 milligrams of potassium hydroxide per gram (mg KOH/g)), (2) Disperbyk 2155 (amine value: 48 mg KOH/g), (3) Disperbyk 2200 (amine value: 18 mg KOH/g), (4) Disperbyk 170 (amine value: 27 mg KOH/g), and (5) imidazole-containing surface-treating agent, all of which are manufactured by BYK, is added together into a dispersing agent of acetone (solubility parameter: 19.9 megaPascals^{1/2} (MPa^{1/2})) and dispersed. The dispersion is aged at room temperature for about 24 hours, and then CSMO, the surface of which is adsorbed with the oligomer or polymer, is washed alternately using acetone and toluene, and vacuum-filtered in a flask and then dried at 150° C. for 30 minutes to provide a CSMO coated with each of the surface-treatment agent.

### Examples 1-1 to 1-4: Manufacture of Composites and Articles and Evaluation wThereof

High density polyethylene (HDPE) having a weight average molecular weight of greater than or equal to about 10⁵ grams per mole (g/mol) is mixed with each of 5% by weight (Example 1-1), 10% by weight (Example 1-2), 15% by weight (Example 1-3), and 20% by weight (Example 1-4) of CSMO in which 17 parts by weight of MgO is supported on 100 parts by weight of carbon black obtained from Synthesis Example 1, based on the total weight of the HDPE and CSMO, to provide composites.

Specifically, each composite is obtained by introducing the amount of HDPE and CSMO together into a twin-screw extruder, melting, and blending the same to provide a pellet. At this time, a temperature profile of the extruder is controlled to divide 8 temperature zones from an inlet at 180° C. to an outlet at 150° C., and a screw speed is 50 to 100 revolutions per minute (rpm). In addition, the obtained pellet is added into an injection machine (HAAKE Minijetll, Thermo Fisher Scientific) and shaped to provide a circular article.

Each of the obtained article is measured for a water vapor transmission rate (WVTR), a tensile strength, an internal impact strength, and a thermal conductivity according to the following methods.

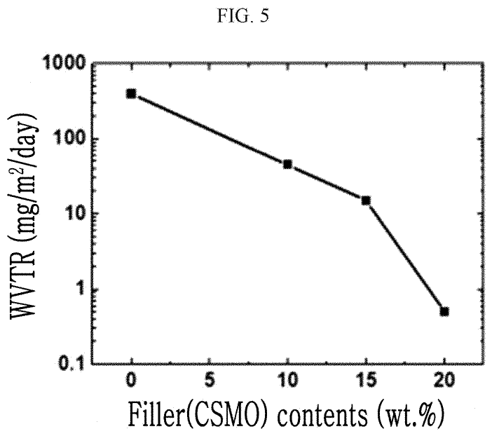

The water vapor transmission rate is measured for each circular article having a thickness of 1 millimeters (mm) and a diameter of 34 mm using Aquatran equipment (Mocon Inc.) at 38° C. under relative humidity of 100% according to ISO15106-3, and the results are shown in FIG. 5.

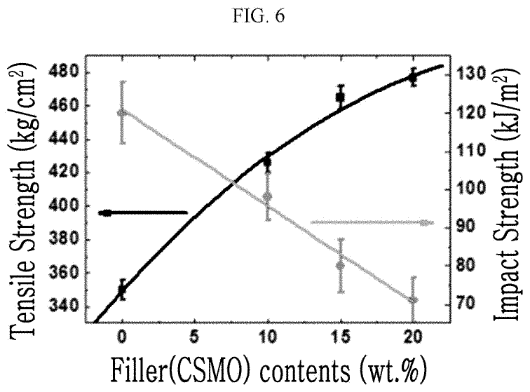

The tensile strength is measured using UTM (Universal Testing Machine) according to ASTM D₆₃₈, and the results are shown in FIG. 6.

The internal impact strength is determined by measuring un-notched type Izod impact strength using Instron (impactor II, CEAST 9050) according to ASTM D₂₆₅, and the results are shown in FIG. 6.

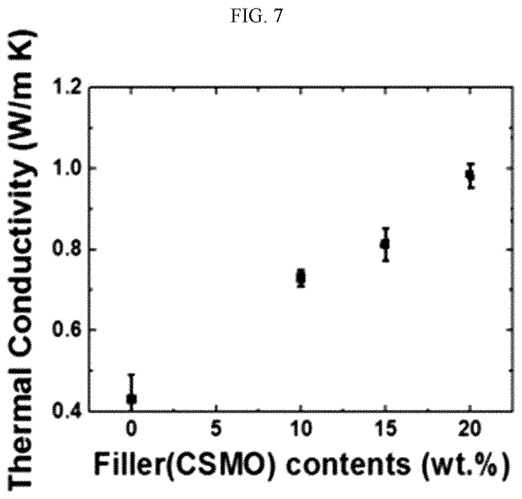

The thermal conductivity in horizontal direction is measured for a circular article having a thickness of 1 mm and a diameter of 25 mm at room temperature by using LFA467 (Netzsch Corp.) according to a laser flash method, and the results are shown in FIG. 7.

As shown from FIG. 5, the water vapor transmission rate decreases as the amount of CSMO increases in the composite, and especially, when the amount of CSMO is 20 weight %, the water vapor transmission rate dramatically reduces to 0.5 milligrams per square meter per day (mg/m²/day).

The thermal conductivity in horizontal direction increases as the amount of CSMO increases.

Again, the tensile modulus increases as the amount of CSMO increases.

As such, the composite including CSMO according to an embodiment achieves low water vapor transmission rate (WVTR), high thermal conductivity, and high mechanical properties simultaneously.

The internal impact strength decreases as the amount of CSMO increases. When the amount of CSMO is 0 (zero), i.e., when the composite does not include CSMO and includes only the HDPE, the internal impact strength is about 450 kilojoules per square meter (kJ/m²), while it decreases to about 71 kJ/m² when the amount of CSMO is 20 weight %. That is, the impact strength may decrease as the amount of CSMO increases. Without wishing to be bound by a specific theory, it is understood that the open spaces between the HDPE chains could absorb the external impact without CSMO. However, the open space might be reduced as the amount of CSMO increases, which may cause decreased impact strength. This decrease of the impact strength would be unfavorable in terms of the mechanical applications of CSMO/HDPE composites. However, the value of the impact strength, 71 kJ/m² may be reasonably acceptable for Li-ion battery packs on EV applications. Further, this impact strength issue could be resolved by using CSMO, of which the surface is treated with the oligomer or polymer, as obtained in Synthesis Example 2.

The composite according to an embodiment, which includes a polymer matrix, a carbonaceous support dispersed in the polymer matrix, and an inorganic moisture-absorber supported on the carbonaceous support, achieves low WVTR, high thermal conductivity, and high mechanical properties.

### Example 2: Manufacture of Composite and Article and Evaluation Thereof

90% by weight of high density polyethylene (HDPE) having a weight average molecular weight of greater than or equal to about 10⁵ g/mol is mixed with 10% by weight of CSMO in which MgO is supported in an amount of 17 parts by weight, based on 100 parts by weight of carbon black to provide a composite, wherein the CSMO is treated on the surface thereof by Disperbyk 2155 according to Synthesis Example 2.

A composite and an article are obtained in accordance with the same procedure as in Example 1, except that the CSMO treated on the surface thereof by Disperbyk 2155 according to Synthesis Example 2 is used. Then, water vapor transmission rate (WVTR), tensile strength, internal impact strength, and thermal conductivity of the obtained article are measured in accordance with the same procedure as in Example 1, and the results are shown in Table 1.

### Example 3: Manufacture of Composite and Article and Evaluation Thereof

85% by weight of high density polyethylene (HDPE) having a weight average molecular weight of greater than or equal to about 10⁵ g/mol is mixed with 15% by weight of CSMO in which MgO is supported in an amount of 17 parts by weight per 100 parts by weight of carbon black to provide a composite, wherein the CSMO is treated on the surface thereof by Disperbyk 2155 according to Synthesis Example 2.

That is, a composite and an article are obtained in accordance with the same procedure as in Example 1, except that 85% by weight of HDPE and 15% by weight of CSMO which is treated on the surface by Disperbyk 2155 are used. Then, a water vapor transmission rate (WVTR), tensile strength, internal impact strength, and thermal conductivity of the obtained article are measured in accordance with the same procedure as in Example 1, and the results are shown in Table 1.

### Example 4: Manufacture of Composite and Article and Evaluation Thereof

85% by weight of high density polyethylene (HDPE) having a weight average molecular weight of greater than or equal to about 10⁵ g/mol is mixed with 15% by weight of CSMO in which MgO is supported in an amount of 17 parts by weight per 100 parts by weight of carbon black to provide a composite, wherein the CSMO is treated on the surface thereof by Disperbyk 2150 according to Synthesis Example 2.

That is, a composite and an article are obtained in accordance with the same procedure as in Example 1, except that 85% by weight of HDPE and 15% by weight of CSMO which is treated on the surface by Disperbyk 2150 are used. Then, water vapor transmission rate (WVTR), tensile strength, internal impact strength, and thermal conductivity of the obtained article are measured in accordance with the same procedure as in Example 1, and the results are shown in Table 1.

### Example 5: Manufacture of Composite and Article and Evaluation Thereof

85% by weight of high density polyethylene (HDPE) having a weight average molecular weight of greater than or equal to about 10⁵ g/mol is mixed with 15% by weight of CSMO in which MgO is supported in an amount of 17 parts by weight per 100 parts by weight of carbon black to provide a composite, wherein the CSMO is treated on the surface thereof by Disperbyk 170 according to Synthesis Example 2.

That is, a composite and an article are obtained in accordance with the same procedure as in Example 1, except that 85% by weight of HDPE and 15% by weight of CSMO which is treated on the surface by Disperbyk 170 are used. Then, water vapor transmission rate (WVTR), tensile strength, internal impact strength, and thermal conductivity of the obtained article are measured in accordance with the same procedure as in Example 1, and the results are shown in Table 1.

### Example 6: Manufacture of Composite and Article and Evaluation Thereof

85% by weight of high density polyethylene (HDPE) having a weight average molecular weight of greater than or equal to about 10⁵ g/mol is mixed with 15% by weight of CSMO in which MgO is supported in an amount of 17 parts by weight per 100 parts by weight of carbon black to provide a composite, wherein the CSMO is treated on the surface thereof by Disperbyk 2200 according to Synthesis Example 2.

That is, a composite and an article are obtained in accordance with the same procedure as in Example 1, except that 85% by weight of HDPE and 15% by weight of CSMO which is treated on the surface by Disperbyk 2200 are used. Then, water vapor transmission rate (WVTR), tensile strength, internal impact strength, and thermal conductivity of the obtained article are measured in accordance with the same procedure as in Example 1, and the results are shown in Table 1.

### Example 7: Manufacture of Composite and Article and Evaluation Thereof

85% by weight of high density polyethylene (HDPE) having a weight average molecular weight of greater than or equal to about 10⁵ g/mol is mixed with 15% by weight of CSMO in which MgO is supported in an amount of 17 parts by weight per 100 parts by weight of carbon black to provide a composite, wherein the CSMO is treated on the surface thereof by an imidazole-containing surface-treating agent according to Synthesis Example 2.

That is, a composite and an article are obtained in accordance with the same procedure as in Example 1, except that 85% by weight of HDPE and 15% by weight of CSMO which is treated on the surface by an imidazole-containing surface-treating agent are used. Then, water vapor transmission rate (WVTR), tensile strength, internal impact strength, and thermal conductivity of the obtained article are measured in accordance with the same procedure as in Example 1, and the results are shown in Table 1.

### Example 8: Manufacture of Composite and Article and Evaluation Thereof

85% by weight of high density polyethylene (HDPE) having a weight average molecular weight of greater than or equal to about 10⁵ g/mol is mixed with 15% by weight of CSMO in which MgO is supported in an amount of 22 parts by weight per 100 parts by weight of carbon black to provide a composite, wherein the CSMO is treated on the surface thereof by Disperbyk 2200 according to Synthesis Example 2.

That is, a composite and an article are obtained in accordance with the same procedure as in Example 6, except that 85% by weight of HDPE and 15% by weight of CSMO which is treated on the surface by Disperbyk 2200 are used, and the amount of MgO per 100 parts by weight of the CSMO is 22 parts by weight instead of 17 parts by weight. Then, water vapor transmission rate (WVTR), tensile strength, internal impact strength, and thermal conductivity of the obtained article are measured in accordance with the same procedure as in Example 1, and the results are shown in Table 1.

### Example 9: Manufacture of Composite and Article and Evaluation Thereof

80% by weight of high density polyethylene (HDPE) having a weight average molecular weight of greater than or equal to about 10⁵ g/mol is mixed with 20% by weight of CSMO in which MgO is supported in an amount of 17 parts by weight per 100 parts by weight of carbon black to provide a composite, wherein the CSMO is treated on the surface thereof by Disperbyk 2200 according to Synthesis Example 2.

That is, a composite and an article are obtained in accordance with the same procedure as in Example 6, except that 80% by weight of HDPE and 20% by weight of CSMO which is treated on the surface by Disperbyk 2200 are used. Then, water vapor transmission rate (WVTR), tensile strength, internal impact strength, and thermal conductivity of the obtained article are measured in accordance with the same procedure as in Example 1, and the results are shown in Table 1.

### Example 10: Manufacture of Composite and Article and Evaluation Thereof

90% by weight of high density polyethylene (HDPE) having a weight average molecular weight of greater than or equal to about 10⁵ g/mol is mixed with 10% by weight of CSMO in which MgO is supported in an amount of 22 parts by weight per 100 parts by weight of carbon black obtained from Synthesis Example 1 to provide a composite.

That is, a composite and an article are obtained in accordance with the same procedure as in Example 1, except that 90% by weight of HDPE and 10% by weight of CSMO in which MgO is supported in an amount of 22 parts by weight per 100 parts by weight of CSMO. Then, water vapor transmission rate (WVTR), tensile strength, internal impact strength, and thermal conductivity of the obtained article are measured in accordance with the same procedure as in Example 1, and the results are shown in Table 1.

### Example 11: Manufacture of Composite and Article and Evaluation Thereof

85% by weight of high density polyethylene (HDPE) having a weight average molecular weight of greater than or equal to about 10⁵ g/mol is mixed with 15% by weight of CSMO in which MgO is supported in an amount of 22 parts by weight per 100 parts by weight of carbon black obtained from Synthesis Example 1 to provide a composite.

That is, a composite and an article are obtained in accordance with the same procedure as in Example 10, except that 85% by weight of HDPE and 15% by weight of CSMO are used. Then, water vapor transmission rate (WVTR), tensile strength, internal impact strength, and thermal conductivity of the obtained article are measured in accordance with the same procedure as in Example 1, and the results are shown in Table 1.

### Comparative Example 1: Manufacture of High Density Polyethylene Article and Evaluation Thereof

An article is manufactured by using 100% by weight (wt %) of a high density polyethylene (HDPE) having a weight average molecular weight of greater than or equal to about 10⁵ g/mol. That is, an article is obtained by using only the polymer HDPE, without using carbon black or an additional inorganic moisture absorber according to Synthesis Example 1 or 2, and water vapor transmission rate (WVTR), tensile strength, internal impact strength, and thermal conductivity of the obtained article are measured in accordance with the same procedure as in Example 1. The results are shown in Table 1.

TABLE 1

| | | | MgO (parts | | | | | |
|---|---|---|---|---|---|---|---|---|
| | | | by weight, | | | Tensile | | |
| | | | based on | | | strength | Impact | Thermal |
| | | | 100 parts | | | (kilograms | strength | conductivity |
| | | | by weight | Surface- | | per square | (kilojoules per | (watts per |
| | HDPE | CSMO | of carbon | treating | WVTR | centimeter | square meter | meter-Kelvin |
| | (wt %) | (wt %) | black) | agent | (g/m²/day) | (kg/cm²)) | (kJ/m²)) | (W/mK)) |
| Ex. 1-2 | 90 | 10 | 17 | — | 0.020 | 417 ± 9 | Unbreakable | — |
| Ex. 2 | 85 | 15 | 17 | Disperbyk | — | 401 ± 12 | Unbreakable | — |
| | | | | 2155 | | | | |
| Ex. 3 | 85 | 15 | 17 | Disperbyk | — | 400 ± 11 | 99 | — |
| | | | | 2155 | | | | |
| Ex. 4 | 85 | 15 | 17 | Disperbyk | — | 393 ± 7 | 101 | 0.49 |
| | | | | 2150 | | | | (vertical) |
| | | | | | | | | 0.69 |
| | | | | | | | | (horizontal) |
| Ex. 5 | 85 | 15 | 17 | Disperbyk | — | — | 97 | — |
| | | | | 170 | | | | |
| Ex. 6 | 85 | 15 | 17 | Disperbyk | 0.053 | 399 ± 13 | Unbreakable | — |
| | | | | 2200 | | | | |
| Ex. 7 | 85 | 15 | 17 | Imidazole- | — | — | 60 | — |
| | | | | containing | | | | |
| Ex. 8 | 85 | 15 | 22 | Disperbyk | 0.073 | 470 ± 8 | 93 | 0.8 |
| | | | | 2200 | | | | (horizontal) |
| Ex. 9 | 80 | 20 | 17 | Disperbyk | — | — | 82 | — |
| | | | | 2200 | | | | |
| Ex. 10 | 90 | 10 | 22 | — | 0.045 | 426 ± 6 | 98 | — |
| Ex. 11 | 85 | 15 | 22 | — | 0.005 | 465 ± 7 | 80 | 1.0 |
| | | | | | | | | (horizontal) |
| Comp. | 100 | 0 | 0 | — | 0.4 | 350 | Unbreakable | 0.3 |
| Ex. 1 | | | | | | | | (vertical) |

As may be seen in Table 1, in the articles of the composites according to Examples 1-2 to 11 including all of a polymer matrix of HDPE, a carbonaceous support dispersed in the polymer matrix (carbon black), and an inorganic moisture absorber of magnesium oxide supported on the carbon black, the water vapor transmission rate (WVTR) is decreased from at least about ⅕ level (Example 10) to at a maximum about 1/100 level (Example 11) compared with the article including only HDPE according to Comparative Example 1, the tensile strength is mostly increased, the impact strength is similar or partly decreased, and the thermal conductivity is further enhanced. That is, it is understood that the article of the composite according to an embodiment including a polymer matrix, a carbonaceous support dispersed in the same, and a nano-sized inorganic moisture absorber supported on the carbonaceous support improves all of moisture transmission resistivity, mechanical properties, and thermal conductivity characteristics.

As understood from Examples 8 and 11, the amounts of the polymer matrix, the carbonaceous support, and the inorganic moisture absorber supported on the carbonaceous support are all same, but the article obtained from the composite according to Example 8 in which the surface of the carbonaceous support is treated with the oligomer or polymer has more enhanced mechanical properties, such as, tensile strength and impact strength, than the article obtained from the composite according to Example 11 including carbonaceous support without performing the surface-treatment, but the article obtained from the composite according to Example 11 has slightly better water vapor transmission rate and thermal conductivity.

In addition, as understood from comparing Example 6 with Example 8 and Example 1 with Example 10, when the amounts of the polymer matrix and the carbonaceous support are same, the article including 17 parts by weight of the inorganic moisture absorber supported on the carbonaceous support (Example 1 and Example 6), based on 100 parts by weight of the carbonaceous support further decreases water vapor transmission rate and further enhances impact strength, compared with the article including 22 parts by weight of the inorganic moisture absorber supported on the carbonaceous support (Example 10 and Example 8), based on 100 parts by weight of the carbonaceous support.

As described above, the article manufactured from the composite including the polymer matrix, the carbonaceous support, and the inorganic moisture absorber supported on the carbonaceous support according to an embodiment may simultaneously ensure moisture transmission resistivity, mechanical properties, and heat dissipation properties. Moisture transmission resistivity, mechanical properties, heat dissipation properties, and the like, or a combination thereof are properties having trade-off relationships, and the properties are difficult to be simultaneously increased. The composite according to an embodiment capable of improving properties and the article including the same may be appropriately applied to, e.g., used in, a variety of devices in which improved properties are desired. The articles may include an energy storage device, such as, a rechargeable lithium battery, a moisture-sensitive electronic device, a portable equipment, and a display device, or the like.

In addition, although a carbonaceous support is primarily described in the Examples, when a transparent support besides, e.g., instead of, the carbonaceous support, and an inorganic moisture absorber, for example, having a particle size of less than or equal to 40 nm, are used, a resulting composite may be applied to, e.g., used in, a display device, for example, an OLED, and the like.

While this disclosure has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A composite comprising
a polymer matrix,
a carbonaceous support, and
an inorganic moisture absorber on the carbonaceous support.

2. The composite of claim 1, wherein the polymer matrix comprises a polycarbonate, a polyethylene, a polypropylene, a polyvinyl, a polyamide, a polyester, a polyphenylene sulfide, a polyphenylene ether, a polyphenylene oxide, a polystyrene, a polyamide, a polycyclic olefin copolymer, an acrylonitrile-butadiene-styrene copolymer, a liquid crystal polymer, a copolymer thereof, or a combination thereof.

3. The composite of claim 1, wherein the polymer matrix comprises a high density polyethylene, a liquid crystal polymer, or a combination thereof.

4. The composite of claim 1, wherein the carbonaceous support has a specific surface area of greater than or equal to about 100 square meters per gram, and a D₅₀ particle diameter of an aggregate of the carbonaceous support is greater than or equal to about 0.1 micrometers.

5. The composite of claim 1, wherein the carbonaceous support comprises carbon black, ketjen black, graphite, expanded graphite, a carbon fiber, a carbon nanoplate, or a combination thereof.

6. The composite of claim 1, wherein the carbonaceous support comprises carbon black.

7. The composite of claim 1, wherein the inorganic moisture absorber comprises silica gel, zeolite, CaO, BaO, MgSO₄, Mg(ClO₄)₂, MgO, P₂O₅, Al₂O₃, CaH₂, NaH, LiAlH₄, CaSO₄, Na₂SO₄, Na₂CO₃, CaCO₃, K₂CO₃, CaCl₂), Ba(ClO₄)₂, Ca, or a combination thereof.

8. The composite of claim 1, wherein the inorganic moisture absorber comprises MgO, CaO, or a combination thereof.

9. The composite of claim 1, wherein the inorganic moisture absorber has a D₅₀ particle diameter of greater than or equal to about 5 nanometers and less than about 1 micrometer.

10. The composite of claim 1, wherein a total amount of the carbonaceous support and the inorganic moisture absorber is greater than or equal to about 5%, based on a total weight of the composite.

11. The composite of claim 1, wherein an amount of the inorganic moisture absorber in the composite is about 3% to about 50%, based on a total weight of the carbonaceous support.

12. The composite of claim 1, wherein the composite further comprises an oligomer or a polymer dissolvable in a solvent having a solubility parameter of about 15 megaPascals^{1/2} to about 30 megaPascals^{1/2}, and the oligomer or polymer comprises an amino group, a hydrophobic functional group, an amphiphilic functional group, or a combination thereof.

13. The composite of claim 12, wherein the hydrophobic functional group of the oligomer or polymer comprises an aliphatic hydrocarbon group, an alicyclic hydrocarbon group, an aromatic hydrocarbon group, a (meth)acryloyl group, a halogen-substituted aliphatic hydrocarbon group, a halogen-substituted alicyclic hydrocarbon group, a halogen-substituted aromatic hydrocarbon group, or a combination thereof.

14. The composite of claim 12, wherein the oligomer or polymer comprises an amino group and an amine value of the amino group is in a range of about 1 milligrams of potassium hydroxide per gram to about 100 milligrams of potassium hydroxide per gram.

15. The composite of claim 12, wherein the oligomer or polymer is present in an amount of less than or equal to about 50 parts by weight per 100 parts by weight of the carbonaceous support.

16. An article comprising the composite of claim 1.

17. The article of claim 16, wherein the article has a water vapor transmission rate of less than about 0.4 grams per square meter per day at a thickness of 1 millimeter, when measured at 38° C. under relative humidity of 100% according to ISO 15106.

18. A battery case comprising the composite of claim 1.

19. A battery comprising
the battery case of claim 18 and
an electrode assembly comprising a positive electrode and a negative electrode within the battery case

20. A composite comprising
a polymer matrix,
a transparent support, and
an inorganic moisture absorber on the transparent support.

21. The composite of claim 20, wherein the transparent support comprises mesoporous silica, mesoporous amorphous silica, porous alumina, or a porous metal oxide configured to form a metal-organic framework, and a D₅₀ particle diameter of the inorganic moisture absorber is less than or equal to about 40 nanometers.
